(19) United States
(12) Patent Application Publication
(10) Pub. No.: US 2013/0163555 A1
(43) Pub. Date: Jun. 27, 2013

(54) Apparatuses and Methods in Relation to Flexible Spectrum Usage for Proximity Communication

(71) Applicants: Samuli Turtinen, Ii (FI); Matti Pikkarainen, Oulu (FI); Timo Koskela, Oulu (FI); Sami-Jukka Hakola, Kempele (FI)

(72) Inventors: Samuli Turtinen, Ii (FI); Matti Pikkarainen, Oulu (FI); Timo Koskela, Oulu (FI); Sami-Jukka Hakola, Kempele (FI)

(73) Assignee: Renesas Mobile Corporation, Tokyo (JP)

(21) Appl. No.: 13/334,409

(22) Filed: Dec. 22, 2011

(30) Foreign Application Priority Data
Dec. 21, 2011 (GB) 1122056.3

(51) Int. Cl. H04W 72/04

(52) U.S. Cl. 370/330

(57) ABSTRACT

The present invention proposes an apparatus, including a communication module, configured to communicate with another apparatus in a first mode, which involves at least one network device in order to establish end-to-end communication between the apparatus and a communication counterpart, or in a second mode, which establishes direct end-to-end communication between the apparatus and a communication counterpart not involving a network device, wherein communication is based on physical resources that are allocated in time and frequency domain based on a resource grid, and a control module, configured to control the communication module to communicate in the first mode based on a first resource grid pattern or to communicate in the second mode based on a second resource grid pattern. Likewise, the present invention addresses a correspondingly adapted network entity, as well as respective methods and computer program products.

### FIELD OF THE INVENTION

The present invention concerns apparatuses and methods in relation to flexible spectrum usage for proximity communication. In particular, the present invention relates to an apparatus configured to communicate with another apparatus in a first mode, which involves at least one network device in order to establish end-to-end communication between the apparatus and a communication counterpart, or in a second mode, which establishes direct end-to-end communication between the apparatus and a communication counterpart not involving a network device, wherein communication is based on physical resources that are allocated in time and frequency domain based on a resource grid.

### BACKGROUND

Mobile data transmission and data services are constantly making progress. With the increasing penetration of such services, a need for increased capabilities of communication systems and/or networks for conveying the data is emerging. Under certain scenarios, network capabilities may represent a bottleneck. Therefore, investigation is being made in communication between devices directly, i.e. without involving network infrastructure, such as device-to-device, D2D, communication.

In particular, the present invention is related to Device-to-Device communication in future LTE systems. A proposal for a study item for the D2D communication was made by Qualcomm Inc. in the 3GPP TSG-RAN #52 plenary, 31 May-3 Jun. 2011.
(Tdoc-RP-110706, “On the need for a 3GPP study on LTE device-to-device discovery and communication”, Qualcomm Incorporated, ftp://ftp.3gpp.org/TSG RAN/TSG RAN/TSGR 52/Docs/,
Tdoc-RP-110707, “Study on LTE Device to Device Discovery and Communication—Radio Aspects”, Qualcomm Incorporated, ftp://ftp.3gpp.org/TSG RAN/TSG RAN/TSGR 52/Docs/, and
Tdoc-RP-110708, “Study on LTE Device to Device Discovery and Communication—Service and System Aspects”, Qualcomm Incorporated, ftp://ftp.3gpp.org/TSG RAN/TSG RAN/TSGR 52/Docs/)

One of the main targets is to evolve the LTE platform in order to intercept the demand of proximity-based applications by studying enhancements to the LTE radio layers that allow devices to discover each other directly over the air, and potentially communicate directly, when this makes sense from a system management point of view, upon appropriate network supervision.

As a cornerstone of the concept proposal, Qualcomm Inc. has strongly proposed the radio level discovery functionality. The discovery process needs also to be coupled with a system architecture and a security architecture that allow the 3GPP operators to retain control of the device behavior, for example to control who can emit discovery signals, when and where, what information these signals should carry, and what actions the corresponding devices should take once they discover each other.

Also, Qulacomm Inc. hitherto proposed (in document US20070211677, “Support for Wide Area Networks and Peer-to-Peer Networks”) a method for D2D communication underlying a cellular system, where D2D communication devices may utilize different symbol length, CP (Cyclic Prefix) length or tone length compared to those utilized in the overlying cellular system. However, this may require separate time resources for the D2D communication if deployed on a same carrier as the cellular system, or a complex receiver implementation in both, D2D and cellular system, to mitigate ISI (Inter Symbol Interference).

In document US20090109950, “Methods and Apparatus for Communicating Information Using Different Types of Symbols”, Qualcomm Inc. further proposes a method for D2D communication where symbols of different of length are utilized for control and data transmissions.

The present invention as described herein below is in general applicable to various telecommunication systems that operate based on a resource grid in time-frequency domain, such as the LTE or LTE-A system.

Merely for purposes of easier explanation of at least principles and at least exemplary implementation aspects of the invention, reference is made to the currently developed/discussed system of LTE (Long Term Evolution) and/or LTE-A (LTE-Advanced). This reference, however, is not limiting the applicability of the present invention to only this system, and the present invention can be applied to various other systems deploying a resource grid in time-frequency domain for communication.

The currently known system of Long Term Evolution LTE is being further developed. When the LTE system concept is further extended in a way that it can be deployed also in co-existence with D2D communication, a network transceiver device such as an eNB should be aware of the conditions prevailing in its area because interference could be caused not only to another system but also to devices or terminals receiving data from the network transceiver device eNB (in cellular communication) as well as to devices communicating in non-cellular but rather D2D communication.

However, regardless of earlier proposals, a feedback RTT (Round Trip Time) in the current LTE system could be inefficient for “local” communication, e.g. Device-to-Device (D2D) communication. E.g., when the other device only gives a feedback responsive to the other device's transmissions, the duration of the feedback is 1 ms due to the duration of the transmission time interval (i.e. TTI duration) of the LTE system.

Thus, there is still a need to further improve such systems.

### SUMMARY

Various aspects of examples of the invention are set out in the claims.

According to a first aspect of the present invention, there is provided
an apparatus, comprising a communication module, configured to communicate with another apparatus in a first mode, which involves at least one network device in order to establish end-to-end communication between the apparatus and a communication counterpart, or in a second mode, which establishes direct end-to-end communication between the apparatus and a communication counterpart not involving a network device, wherein communication is based on physical resources that are allocated in time and frequency domain based on a resource grid, and a control module, configured to control the communication module to communicate in the first mode based on a first resource grid pattern or to communicate in the second mode based on a second resource grid pattern;
and likewise, there is provided
an apparatus, comprising a communication module, configured to communicate with a terminal in a first mode, which involves at least the apparatus in order to establish end-to-end communication between the terminal and a communication counterpart thereof, and wherein communication is based on physical resources that are allocated in time and frequency domain based on a resource grid, and a control module, configured to inform the terminal of resource grid patterns to be applied when communicating in one of the first mode and a second mode, wherein in the second mode, direct end-to-end communication between the terminal and its communication counterpart is established, so as to apply in the first mode a first resource grid pattern or to apply in the second mode a second resource grid pattern.

Advantageous further developments are as set out in the respective dependent claims.

According to a second aspect of the present invention, there is provided
a method, comprising providing an apparatus for communication with another apparatus in a first mode, which involves at least one network device in order to establish end-to-end communication between the apparatus and a communication counterpart, or in a second mode, which establishes direct end-to-end communication between the apparatus and a communication counterpart not involving a network device, wherein communication is based on physical resources that are allocated in time and frequency domain based on a resource grid, and controlling the communication so as to communicate in the first mode based on a first resource grid pattern or to communicate in the second mode based on a second resource grid pattern;
and likewise, there is provided
a method, comprising providing an apparatus for communication with a terminal in a first mode, which involves at least the apparatus in order to establish end-to-end communication between the terminal and a communication counterpart thereof, and wherein communication is based on physical resources that are allocated in time and frequency domain based on a resource grid, and informing the terminal of resource grid patterns to be applied when communicating in one of the first mode and a second mode, wherein in the second mode, direct end-to-end communication between the terminal and its communication counterpart is established, so as to apply in the first mode a first resource grid pattern or to apply in the second mode a second resource grid pattern.

Advantageous further developments are as set out in the respective dependent claims.

According to a third aspect of the present invention, there are provided respective computer program products comprising computer-executable components which, when the programs are run on a computer, perform the method aspects mentioned above in connection with the respective method aspects.

The above computer program product/products may be embodied as a computer-readable storage medium.

The above proposals thus advantageously enable co-existence of D2D communication with legacy LTE systems while also enabling more flexible scheduling opportunities. Control of the cellular and partly also of the D2D communication is still residing at and exerted by the eNB as a network transceiver device. Although this may result in shorter interleaving periods and may potentially increases scheduling complexity either in the eNB or in a D2D pair/cluster, the advantages are worth accepting such other effects which do not impede performance.

### BRIEF DESCRIPTION OF DRAWINGS

For a more complete understanding of example embodiments of the present invention, reference is now made to the following descriptions taken in connection with the accompanying drawings in which:

FIG. 1 (FIGS. 1(a) and 1(b)) illustrate a respective schematic block diagram of apparatuses, such as an evolved NodeB, eNB, as a network transceiver station and a user equipment, UE, as a terminal device, according to exemplary embodiments;

FIG. 2 illustrates (in FIGS. 2(b) and (c)) exemplary examples of resource grid pattern allocations for terminals in device-to-device communication (D2D) according to exemplary aspects of the invention and the difference to a resource grid pattern allocation for cellular communication according to e.g. the LTE or LTE-A;

### DESCRIPTION OF EXEMPLARY EMBODIMENTS

Exemplary aspects of the invention will be described herein below. For description purposes only, reference is made to an example of LTE as a network environment, in which the present invention is suitable to be implemented. Only for this reason, some of the LTE terminology will be used also for describing the present invention, though this is not intended to impart any restricting meaning to the terms used.

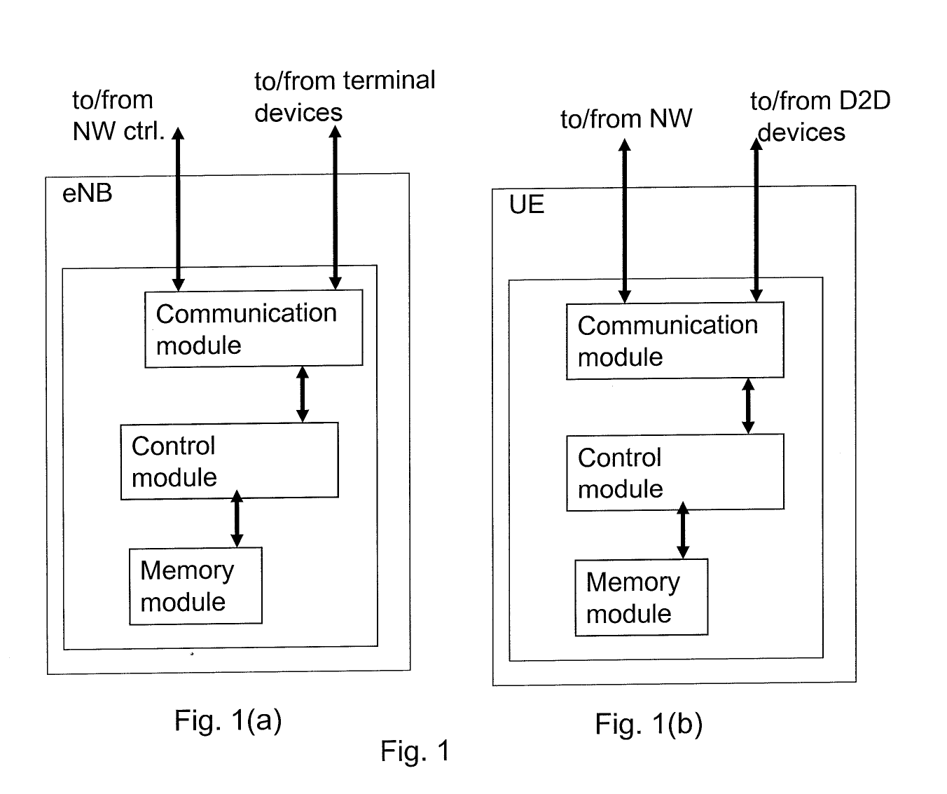

Generally, the invention is implemented in apparatuses as for example schematically shown in FIG. 1.

FIG. 1 (a) illustrates an apparatus in relation to a network transceiver device such as an evolved Node B, eNB, or the like. The apparatus can for example be a part or a module (e.g. chipset) of the network transceiver device such as the eNB. The apparatus comprises a communication module configured for communication with another network entity as well as for communication with terminal devices UE. That is, via the communication module, the apparatus and/or eNB may also communicate with a super-ordinated network entity located in e.g. the core network, such as a mobility management entity MME. Likewise, the eNB communicates via the communication module with terminals such as user equipments UE or other terminals. The communication module can bi-directionally exchange data with a control module of the apparatus. The control module may exchange data with a memory module. The control module can be any kind of a processor or CPU or ASIC or the like, whether implemented in hardware or software. The memory module can be a volatile or non-volatile memory such as a RAM or ROM, EPROM, EEPROM, Flash-memory or the like. The memory module stores software code portions to be executed by the control module, in case of a software implementation. Also, the memory module may store, at least temporarily, other any data. Also, in at least an exemplary embodiment, the memory keeps information as configured by the network to the apparatus, and/or as to be configured by the eNB/apparatus to the terminal devices, as will be explained in more detail herein below.

FIG. 1 (b) illustrates an apparatus in relation to a terminal device such as a user equipment UE, or the like. The apparatus can for example be a part or a module (e.g. chipset) of the terminal device such as the UE.

The apparatus comprises a communication module configurable into i) a first mode, for communication with a network entity, i.e. in a cellular communication mode of the terminal, which involves the network transceiver device eNB in order to establish end-to-end communication between the terminal and a communication counterpart such as another terminal,

as well as into

ii) a second mode, for communication with one or more other terminal devices UE, i.e. in a non-cellular communication mode of the terminal, which does not involve the network transceiver device eNB in order to establish end-to-end communication between the terminal and a communication counterpart such as another terminal, but which mode establishes communication between terminal devices directly and is referred to as device-to-device, D2D, mode.

That is, via the communication module, the apparatus and/or UE may either communicate via the network entity with another terminal device, or directly with another terminal device (without involvement of an eNB). The communication module can bi-directionally exchange data with a control module of the apparatus. The control module may exchange data with a memory module. The control module can be any kind of a processor or CPU or ASIC or the like, whether implemented in hardware or software. The memory module can be a volatile or non-volatile memory such as a RAM or ROM, EPROM, EEPROM, Flash-memory or the like. The memory module stores software code portions to be executed by the control module, in case of a software implementation. Also, the memory module may store, at least temporarily, other any data. Also, in at least an exemplary embodiment, the memory keeps information as configured by the network device eNB to the apparatus, as will be explained in more detail herein below.

Thus, having briefly described at least exemplarily a basic constitution of the respective apparatuses, a more detailed description of the apparatuses in relation to an imparted functionality will subsequently be given.

A terminal such as a UE as an apparatus thus comprises a communication module, configured to communicate with another apparatus in a first mode, which involves at least one network device in order to establish end-to-end communication between the apparatus and a communication counterpart, or in a second mode, which establishes direct end-to-end communication between the apparatus and a communication counterpart not involving a network device. Communication is based on physical resources that are allocated in time and frequency domain based on a resource grid. The apparatus (UE or modem thereof) comprises a control module that is configured to control the communication module to communicate in the first mode based on a first resource grid pattern or to communicate in the second mode based on a second resource grid pattern. The communication module is further configured to communicate with a network device, and the control module is configured to receive resource grid pattern allocations to be applied in the first and second modes from the network device such as eNB or the like.

Generally, the first and second resource grid patterns are distinct in at least one of a resource grid pattern allocated in frequency and time domain. However, the following description focuses on the time domain to explain distinct resource grid patterns, although principles taught in that regard may be transferred also to frequency domain, i.e. resource grid patterns may be distinct in frequency/bandwidth domain. If so, resource grid patterns would be allocated and distinguishable for the first and second modes on subcarrier basis rather than on symbol basis, or of course, resource grid patterns would be allocated and distinguishable on the basis of both, subcarrier and symbol basis.

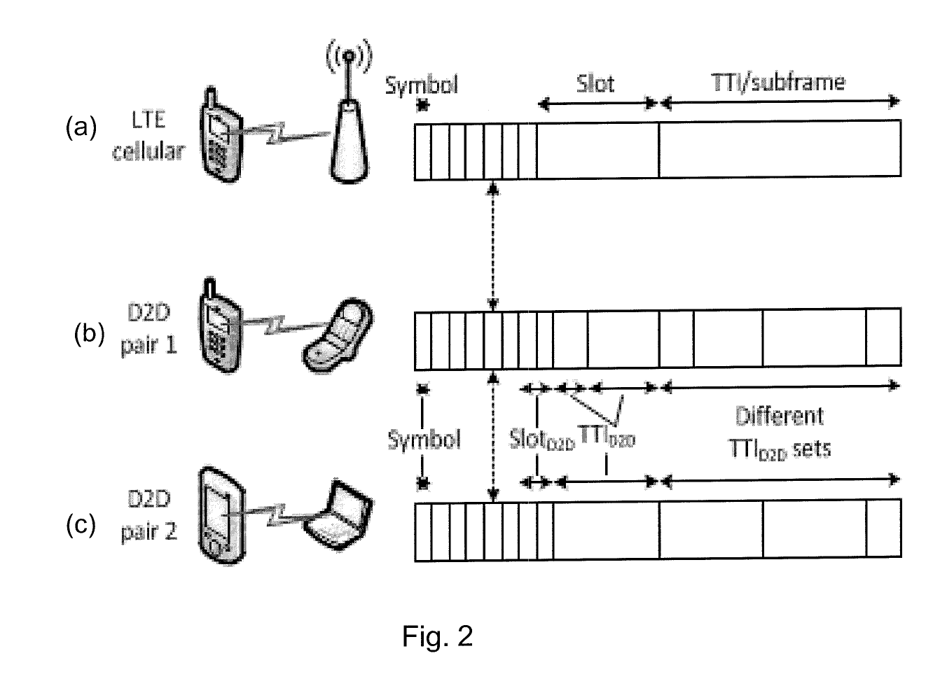

For now, focus is laid on the first and second resource grid patterns being distinct in terms of a resource grid pattern allocated in time domain. In this regard, as is shown also in FIG. 2, the resource grid in time domain is based on individual symbols and a plurality of adjacent symbols form a slot. The first and second resource grid patterns are distinct in terms of the plurality of symbols forming a slot in the first and second modes. Also, according to an exemplary aspect of the present invention, a slot duration in the first mode is a multiple of the slot duration in the second mode. The resource grid in time domain is based on individual symbols, a plurality of adjacent symbols form a slot, and a plurality of slots represent a transmission time interval, wherein in the second mode, according to at least an exemplary aspect of the present invention, transmission time intervals differ dependent on a type of information to be transmitted (control channel information, feedback channel information, payload channel information, or the like), while in the first mode, a unique transmission time interval is applied irrespective of the type of information. Note that in the second mode, the transmission time intervals are respective multiples of the slot duration in the second mode. A set of transmission time intervals in the second mode have a length of one or more transmission time intervals in the first mode.

A network transceiver device such as a an evolved NodeB, eNB comprises an apparatus, comprising a communication module that is configured to communicate with a terminal in a first mode, which involves at least the apparatus in order to establish end-to-end communication between the terminal and a communication counterpart thereof. Likewise, communication is based on physical resources that are allocated in time and frequency domain based on a resource grid. The apparatus or eNB further is equipped with a control module that is configured to inform the terminal of resource grid patterns to be applied when communicating in one of the first mode and a second mode, wherein in the second mode, direct end-to-end communication between the terminal and its communication counterpart is established, so as to apply in the first mode a first resource grid pattern or to apply in the second mode a second resource grid pattern. The control module is configured to inform a plurality of second resource grid pattern allocations to terminals. In such exemplary scenario, in case the number of second resource grid patterns equals the number of groups of terminals in D2D communication, each group of terminals being in communication with each other in the second mode may apply a different one of second resource grid patterns. However, if a number of second resource grid patterns is less than the number of groups, terminals of different groups may also apply the same second resource grid pattern as another group (thus reusing such resource grid pattern) when communicating in the D2D mode. More generally, in case of a plurality of resource grid patterns, among groups of terminals being in communication with each other in the second mode, different second resource grid patterns are applicable. A group of terminals being in D2D communication comprises a minimum of two terminals, but may comprise more than two. A group of more than two terminals in D2D communication may also be referred as a cluster.

Other aspects in terms of the resource grid patterns are similar to those laid down above with regard to the terminal aspect.

FIG. 2 (a) shows a resource grid pattern (in time domain) of the cellular LTE system (representing the first mode). Others such as UMTS may likewise be similarly representative for such first mode. The Figure illustrates time domain only, though a resource grid pattern is also present in frequency (bandwidth) domain. From left to right in the FIG. 2(a) is shown a plurality of symbols as smallest unit in time domain. Typically, in LTE, 7 symbols form a so-called slot, as shown in the middle section, and 2 slots form a so-called subframe (right hand portion). A subframe is representative of a transmission time interval

FIGS. 2(b) and (c) show resource grid patterns as allocated to a first and a second D2D device pair (or cluster). As shown, those grids rely on the same symbols and symbols are synchronized. Different resource grid patterns are allocated in term of the slot duration and/or slot timing. E.g. in FIG. 2(b) and(c), 2 symbols form a slot.

Further, slots are grouped in units of respective transmission time intervals TTI, which, according to an exemplary aspect of the invention, differ dependent on the type of information they transmit. First and second D2D pairs in turn differ in terms of TTI D2D sets, which are “fitted” into one subframe TTI of the LTE system. That is, in FIG. 2(b), for example, 4 TTI's are present within the time of one TTI/subframe of the LTE grid (FIG. 2(a)), while in FIG. 2(c), for example, 3 TTI's are present within the time of one TTI/subframe of the LTE grid (FIG. 2(a)).

Generally, in LTE, 7 symbols which are present over 12 subcarriers form a resource block RB within a slot, two slots constitute a subframe, 10 subframes constitute a radioframe. The present invention proposes to apply a different resource grid patterning to be applied by devices being a second communication mode, i.e. D2D communication. Patterning can be applied in time domain but potentially also on frequency domain. As mentioned above, for D2D communication, a different number than 7, (less than 7) symbols are used to constitute a slot, and also different TTI's are applied depending on the information type conveyed in those TTIs.

Thus, as at least in aspects also described herein before, in a first exemplary embodiment, a D2D pair or a D2D cluster (comprising more than a pair of terminal devices) exploits different slot timing as identified in an overlying cellular system, e.g. LTE system. This aspect of the embodiment further comprises that the cellular system slot time is a multiple of the said D2D slot time.

Further, as described herein before, in a second (alternative or additional) embodiment, a D2D pair/cluster exploits different transmission time intervals (TTI) for different type of information to transmit, e.g., control, data, feedback information etc. Such aspect further comprises that the D2D TTIs are a multiple of the D2D slot time. Further, this aspect encompasses that one or multiple TTIs of an overlying cellular system correspond to a set of the said D2D TTIs. In addition, multiple D2D pairs/clusters may exploit simultaneously D2D TTIs of different of lengths, though it has to be ensured that the D2D slot time as well as symbol time is synchronized.

For the first and second embodiments as outlined above, the network (eNB) configures the D2D slot time and TTIs used in the cell (area) in which D2D is deployed. This further comprises that the D2D pair/cluster jointly allocates a set of the said D2D TTIs to exploit for resources they have been allocated in the said cell. Further, the set of the D2D TTIs may be (semi-)persistent, dynamic or fixed but not limited to these options.

The introduction of shorter TTI enables more efficient HARQ operation due to potentially faster retransmissions. From the packet scheduling point of view, shorter TTI offers finer scheduling granularity with shorter feedback delays, and therefore better adaptation to the current radio conditions resulting in better performance and energy efficiency.

As long as the symbol timing of D2D TTIs is aligned with the overlying cellular system, the co-existence with the, e.g., legacy LTE system is guaranteed.

The disadvantage of shorter TTI is impaired coverage caused by shorter interleaving period and reduced bit rate within the TTI. However, taken into account the nature of D2D communications, the coverage should not be a problem. In fact in some cases longer TTIs could be used for carrying critical information and hence ensure the coverage of for example control information.

FIG. 2 (b) and (c) illustrate exemplary scenarios according to at least individual aspects of the invention and in comparison to a scenario according to LTE cellular communication shown in FIG. 2(a).

That is, in the uppermost part of FIG. 2 (2(a)), symbol/slot/TTI lengths of the LTE based cellular system is shown, and in the lower two parts (2(b)&(c)), different D2D pairs with different D2D TTI sets are illustrated. The figure shows that all communication is synchronized at symbol basis, also for both D2D pairs, slot duration Slot_{D2D} is the same. Furthermore, both D2D pairs have different TTI_{D2D} sets corresponding to the length of one TTI of the cellular system.

The above proposals enable co-existence of D2D communication with legacy LTE systems while also enabling more flexible scheduling opportunities. Control of the cellular and partly also of the D2D communication is still residing at and exerted by the eNB as a network transceiver device. Although this may result in shorter interleaving periods and may potentially increases scheduling complexity either in the eNB or in a D2D pair/cluster, the advantages are worth accepting such other effects which do not impede performance.

Also, the method, devices and computer program products presented herein are generally applicable to wireless modems in devices and networks, whether those conform to LTE, LTE-A, WLAN, or any other wireless communication standard or standards, as long as the devices are capable to perform communication in one of two modes, i.e. a “cellular” mode, or more generally a mode involving network infrastructure for end-to-end communication between devices, and a direct mode without network involvement such as so-called D2D communication.

Other systems can benefit also from the principles presented herein as long as they have identical or similar properties associated thereto.

Embodiments of the present invention may be implemented in software, hardware, application logic or a combination of software, hardware and application logic. The software, application logic and/or hardware generally reside on an apparatus that can be a module or chipset or a part thereof of a wireless modem of a device such as a network transceiver device such as an eNB, or a terminal device such as a user equipment UE.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment or evolved NodeB.

The present invention relates in particular but without limitation to mobile communications, for example to carrier aggregation deployment environments under WCDMA, LTE, WIMAX and WLAN and can advantageously be implemented in user equipments or smart phones, or personal computers connectable to (useable in) such networks. That is, it can be implemented as/in chipsets to connected devices, and/or modems thereof. More generally, all products which contain a correspondingly configured apparatus will see improvement with the invention being implemented thereto.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The present invention proposes an apparatus, comprising a communication module, configured to communicate with another apparatus in a first mode, which involves at least one network device in order to establish end-to-end communication between the apparatus and a communication counterpart, or in a second mode, which establishes direct end-to-end communication between the apparatus and a communication counterpart not involving a network device, wherein communication is based on physical resources that are allocated in time and frequency domain based on a resource grid, and a control module, configured to control the communication module to communicate in the first mode based on a first resource grid pattern or to communicate in the second mode based on a second resource grid pattern. Likewise, the present invention addresses a correspondingly adapted network entity, as well as respective methods and computer program products.

### LIST OF EXEMPLARY ACRONYMS AS USED HEREIN ABOVE

CP Cyclic Prefix
D2D Device-to-Device
eNB Evolved Node B
ISI Inter Symbol Interference
LTE Long Term Evolution
RTT Round Trip Time
TTI Transmission Time Interval

1. An apparatus, comprising
a communication module,
configured to communicate with another apparatus
in a first mode, which involves at least one network device in order to establish end-to-end communication between the apparatus and a communication counterpart, or
in a second mode, which establishes direct end-to-end communication between the apparatus and a communication counterpart not involving a network device,
wherein communication is based on physical resources that are allocated in time and frequency domain based on a resource grid, and
a control module, configured to control the communication module to communicate in the first mode based on a first resource grid pattern or to communicate in the second mode based on a second resource grid pattern.

2. An apparatus according to claim 1, wherein
the communication module is further configured to communicate with a network device, and wherein
the control module is configured to receive resource grid pattern allocations to be applied in the first and second modes.

3. An apparatus according to claim 1, wherein
the first and second resource grid patterns are distinct in at least one of a resource grid pattern allocated in frequency and time domain.

4. An apparatus according to claim 1, wherein
the first and second resource grid patterns are distinct in terms of a resource grid pattern allocated in time domain.

5. An apparatus according to claim 4, wherein
the resource grid in time domain is based on individual symbols and a plurality of adjacent symbols form a slot, wherein
the first and second resource grid patterns are distinct in terms of the plurality of symbols forming a slot in the first and second modes.

6. An apparatus according to claim 5, wherein
a slot duration in the first mode is a multiple of the slot duration in the second mode.

7. An apparatus according to claim 5, wherein
the resource grid in time domain is based on individual symbols, a plurality of adjacent symbols form a slot, and a plurality of slots represent a transmission time interval, wherein
in the second mode, transmission time intervals differ dependent on a type of information to be transmitted, while in the first mode, a unique transmission time interval is applied irrespective of the type of information.

8. An apparatus according to claim 7, wherein
in the second mode, the transmission time intervals are respective multiples of the slot duration in the second mode.

9. An apparatus according to claim 7, wherein
a set of transmission time intervals in the second mode have a length of one or more transmission time intervals in the first mode.

10. An apparatus, comprising
a communication module,
configured to communicate with a terminal
in a first mode, which involves at least the apparatus in order to establish end-to-end communication between the terminal and a communication counterpart thereof, and
wherein communication is based on physical resources that are allocated in time and frequency domain based on a resource grid, and
a control module,
configured to inform the terminal of resource grid patterns to be applied when communicating in one of the first mode and a second mode, wherein in the second mode, direct end-to-end communication between the terminal and its communication counterpart is established, so as to apply in the first mode a first resource grid pattern or to apply in the second mode a second resource grid pattern.

11. An apparatus according to claim 10,
wherein the control module is configured to inform a plurality of second resource grid pattern allocations to terminals, so that among groups of terminals being in communication with each other in the second mode, different second resource grid patterns are applied.

12. An apparatus according to claim 10, wherein
the first and second resource grid patterns are distinct in at least one of a resource grid pattern allocated in frequency and time domain.

13. An apparatus according to claim 10, wherein
the first and second resource grid patterns are distinct in terms of a resource grid pattern allocated in time domain.

14. An apparatus according to claim 13, wherein
the resource grid in time domain is based on individual symbols and a plurality of adjacent symbols form a slot, wherein
the first and second resource grid patterns are distinct in terms of the plurality of symbols forming a slot in the first and second modes.

15. An apparatus according to claim 14, wherein
a slot duration in the first mode is a multiple of the slot duration in the second mode.

16. An apparatus according to claim 14, wherein
the resource grid in time domain is based on individual symbols, a plurality of adjacent symbols form a slot, and a plurality of slots represent a transmission time interval, wherein
in the second mode, transmission time intervals differ dependent on a type of information to be transmitted, while in the first mode, a unique transmission time interval is applied irrespective of the type of information.

17. An apparatus according to claim 16, wherein
in the second mode, the transmission time intervals are respective multiples of the slot duration in the second mode.

18. An apparatus according to claim 16, wherein
a set of transmission time intervals in the second mode have a length of one or more transmission time intervals in the first mode.

19. A method, comprising:
providing an apparatus for communication with another apparatus
in a first mode, which involves at least one network device in order to establish end-to-end communication between the apparatus and a communication counterpart, or
in a second mode, which establishes direct end-to-end communication between the apparatus and a communication counterpart not involving a network device,
wherein communication is based on physical resources that are allocated in time and frequency domain based on a resource grid, and
controlling the communication so as to communicate in the first mode based on a first resource grid pattern or to communicate in the second mode based on a second resource grid pattern.

20. A method according to claim 19, wherein
the communication further comprises communicating with a network device, and wherein
the controlling further comprises receiving resource grid pattern allocations to be applied in the first and second modes.

21. A method according to claim 19, wherein
the first and second resource grid patterns are distinct in at least one of a resource grid pattern allocated in frequency and time domain.

22. A method according to claim 19, wherein
the first and second resource grid patterns are distinct in terms of a resource grid pattern allocated in time domain.

23. A method according to claim 22, wherein
the resource grid in time domain is based on individual symbols and a plurality of adjacent symbols form a slot, wherein
the first and second resource grid patterns are distinct in terms of the plurality of symbols forming a slot in the first and second modes.

24. A method according to claim 23, wherein
a slot duration in the first mode is a multiple of the slot duration in the second mode.

25. A method according to claim 23, wherein
the resource grid in time domain is based on individual symbols, a plurality of adjacent symbols form a slot, and a plurality of slots represent a transmission time interval, wherein
in the second mode, transmission time intervals differ dependent on a type of information to be transmitted, while in the first mode, a unique transmission time interval is applied irrespective of the type of information.

26. A method according to claim 25, wherein
in the second mode, the transmission time intervals are respective multiples of the slot duration in the second mode.

27. A method according to claim 25, wherein
a set of transmission time intervals in the second mode have a length of one or more transmission time intervals in the first mode.

28. A method, comprising
providing an apparatus for communication with a terminal
in a first mode, which involves at least the apparatus in order to establish end-to-end communication between the terminal and a communication counterpart thereof, and
wherein communication is based on physical resources that are allocated in time and frequency domain based on a resource grid, and
informing the terminal of resource grid patterns to be applied when communicating in one of the first mode and a second mode,
wherein in the second mode, direct end-to-end communication between the terminal and its communication counterpart is established, so as to apply in the first mode a first resource grid pattern or to apply in the second mode a second resource grid pattern.

29. A method according to claim 28,
further comprising informing a plurality of second resource grid pattern allocations to terminals, so that among groups of terminals being in communication with each other in the second mode, different second resource grid patterns are applied.

30. A method according to claim 28, wherein
the first and second resource grid patterns are distinct in at least one of a resource grid pattern allocated in frequency and time domain.

31. A method according to claim 28, wherein
the first and second resource grid patterns are distinct in terms of a resource grid pattern allocated in time domain.

32. A method according to claim 31, wherein
the resource grid in time domain is based on individual symbols and a plurality of adjacent symbols form a slot, wherein
the first and second resource grid patterns are distinct in terms of the plurality of symbols forming a slot in the first and second modes.

33. A method according to claim 32, wherein
a slot duration in the first mode is a multiple of the slot duration in the second mode.

34. A method according to claim 32, wherein
the resource grid in time domain is based on individual symbols, a plurality of adjacent symbols form a slot, and a plurality of slots represent a transmission time interval, wherein
in the second mode, transmission time intervals differ dependent on a type of information to be transmitted, while in the first mode, a unique transmission time interval is applied irrespective of the type of information.

35. A method according to claim 34, wherein
in the second mode, the transmission time intervals are respective multiples of the slot duration in the second mode.

36. A method according to claim 34, wherein
a set of transmission time intervals in the second mode have a length of one or more transmission time intervals in the first mode.

37. A computer program product, comprising computer-executable components which, when the program is run on a computer, perform the method according to claim 19.

38. A computer program product, comprising computer-executable components which, when the program is run on a computer, perform the method according to claim 28.
